(19) United States
(12) Patent Application Publication
(10) Pub. No.: US 2004/0135771 A1
(43) Pub. Date: Jul. 15, 2004

(54) Pointing device with peripheral device control panel

(75) Inventor: Kenneth J. Rieck, Victor, NY (US)

Correspondence Address: Patrick D. Floyd, Fay, Sharpe, Fagan, Minnich & McKee, LLP, Seventh Floor, 1100 Superior Avenue, Cleveland, OH, 44114-2579, US

(73) Assignee: Xerox Corporation

(21) Appl. No.: 10/342,874

(22) Filed: Jan. 15, 2003

(51) Int. Cl. G09G 5/08

(52) U.S. Cl. 345/163

(57) ABSTRACT

A computer pointing device having an symbol control actuator for providing user control of a computer graphic user interface. The pointing device includes a peripheral device control panel having one or more actuators for controlling a peripheral device connected to the computer. The peripheral device control panel on the pointing device can be similar to the control panel disposed on the peripheral device having similar actuators arranged in a similar configuration.

### BACKGROUND OF THE INVENTION

The present invention relates to a pointing device for use with a computer graphic user interface, and more particularly to a pointing device having a control panel for controlling a computer peripheral device.

Computer peripheral devices connected to a computer receive commands from the computer to perform specified tasks. For example, printers receive print commands from the computer to commence the generation of printed representations of the print data they receive. Also, copiers can be directed to perform copying tasks via a connected computer.

Typically, a peripheral device will have a control panel mounted thereon which enables the user to input specific commands for controlling the device. The control panel includes actuators, such as buttons, knobs, etc. which are actuated by the user to input the control commands. However, it is sometimes necessary or desirable that the peripheral device be located where it is not readily physically accessible or is obscured from the view of a user. It may then be inconvenient, or even impossible for such a user to view and use the control panel of that device. It is therefor desirable to enable the user to control the peripheral device from the remote location.

### BRIEF DESCRIPTION OF THE INVENTION

According to the present invention, a new and improved computer pointing device is provided.

In accordance with a first aspect of the invention, computer pointing device includes a peripheral device control panel for controlling a peripheral device connected to a computer.

In accordance with a second aspect of the invention, the computer pointing device peripheral device control panel includes one or more actuators for providing signals when actuated by a user for controlling the peripheral device.

In accordance with another aspect of the invention, the computer pointing device peripheral device control panel is similar to the control panel disposed on the peripheral device. The computer pointing device peripheral device control panel actuators are similar to at least some of the actuators of the peripheral device control panel and arranged in a similar configuration.

In accordance with yet another aspect of the invention, the computer pointing device is a computer mouse further including symbol control actuators.

### BRIEF DESCRIPTION OF THE DRAWINGS

The drawings are only for purposes of illustrating preferred embodiments and are not to be construed as limiting the invention. The invention may take form in various components and arrangements of components, and in various steps and arrangements of steps, preferred embodiments of which will be illustrated in the accompanying drawings wherein:

FIG. 1 is a diagram illustrating a pointing device having a control panel for controlling a peripheral device connected to a computer;

FIG. 2 is a plan view of an embodiment of the pointing device illustrating a computer mouse having a peripheral device control panel; and

FIG. 3 is a plan view of an alternate embodiment of a pointing device illustrating a computer mouse having a peripheral device control panel.

### DETAILED DESCRIPTION OF THE INVENTION

It is to be understood that the specific devices and processes illustrated in the attached drawings, and described in the following specification are simply exemplary embodiments of the inventive concepts defined in the appended claims. Hence, specific examples and characteristics relating to the embodiments disclosed herein are not to be considered as limiting, unless the claims expressly state otherwise.

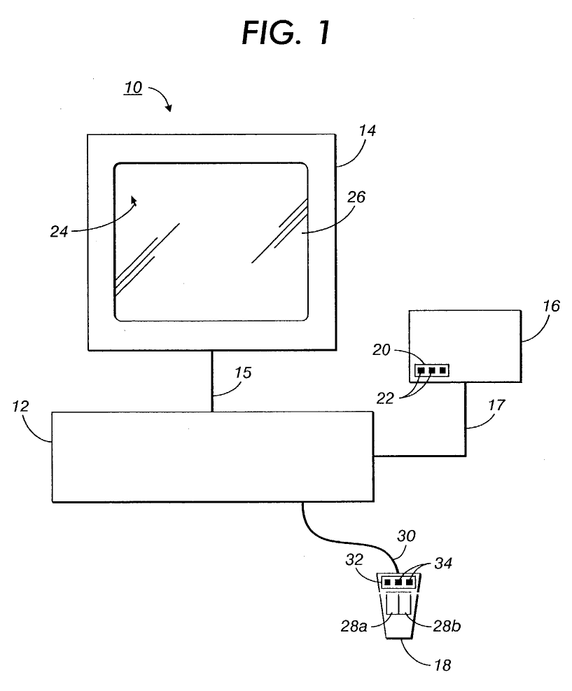

Referring to FIG. 1, a computing system shown generally at 10 includes a computer 12, a monitor 14, a peripheral device 16 and a pointing device 18. The computer 12 can be any known computer, including a personal computer. The computer 12 can be connected for communication with other computers (not shown) in a known networked configuration or it can be standalone computer. The monitor 14 is connected to the computer 12 as shown at 15 in any suitable known manner to display information in a visual manner to the user.

The peripheral device 16 can be any suitable known peripheral device connected to the computer 12, including but not limited to a printer, copier, fax machine, etc. or a multifunction device which can perform the functions of any combination of the peripheral devices. The peripheral device 16 is connected to the computer 12, or the computer network (not shown) at 17 in any suitable known manner.

The peripheral device 16 typically includes a control panel 20 which includes actuators 22 for providing control signals when manipulated by the user for controlling the peripheral device. The actuators 22 may be any known actuators for providing control signals, including but not limited to buttons, knobs, wheels, joy sticks, etc. For example, a printer can include a print button, an offline button, and a form feed button which commence these named actions when pressed by the user.

The pointing device 18 can be any pointing device for use with the computer 12 for manipulating a pointer 24 displayed by the monitor 14. The pointing device 18 can be used to manipulate the pointer 24 to control a graphic user interface 26 as displayed on the monitor 14. The graphic user interface 26 can be any suitable known graphic user interface having symbols for causing the computer 12 to perform tasks or operations when pointed to by the pointer 24 or manipulated by a user using the pointing device 18.

The pointing device 18 can include one or more symbol control actuators 28 for providing control signals to the computer 12 when actuated by the user to manipulate the symbols in the graphic user interface 26 in a known manner. The symbol control actuators 28 can be buttons, wheels, joysticks, or any other suitable known actuators for providing the control signals to the computer when actuated by the user. The pointing device 18 is connected to the computer at 30 in any suitable known manner, such as for example by any suitable known wired connection or any suitable known wireless connection.

The pointing device 18 includes a peripheral device control panel shown generally at 32, for controlling the operation of a peripheral device 16 as described in further detail below. For the purpose of example, the pointing device 18 is shown and described below as a computer mouse, although it can be any suitable known pointing device including but not limited to a computer mouse, trackball, pen-based pointing device, etc.

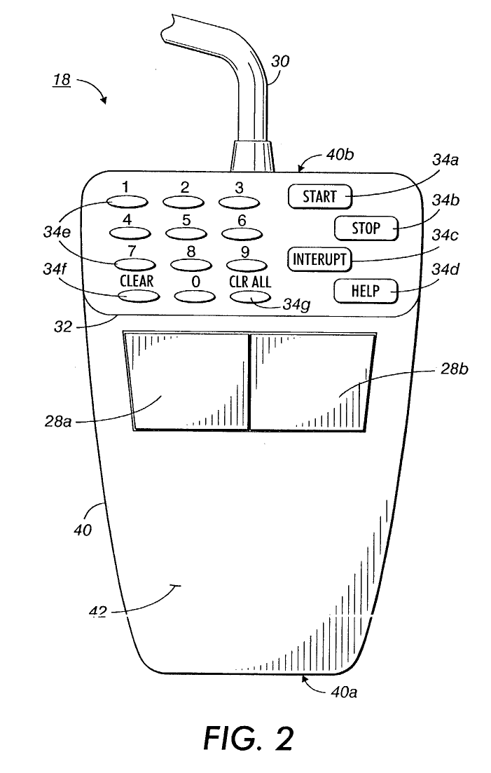

Referring now to FIG. 2, the computer mouse 18 with the peripheral device control panel 32 is shown in greater detail. The peripheral device control panel 32 includes one or more actuators 34 for providing signals to the computer via the connection 30 for controlling the peripheral device 16. The actuators 34 can be switches, buttons, knobs, wheels, or any other suitable known actuators for providing signals when actuated.

The actuators 34 are preferably each assigned to control one or more particular tasks performed by the peripheral device. For example, if the peripheral device 16 is a copier, the pointing device 18 can include a control panel 32 having actuators 34 which control specific copier functions. Examples include, but are not limited to a start actuator 34a for causing the copier to begin copying and/or scanning, a stop actuator 34b which stops the copier, an interrupt actuator 34c which interrupts the copier, and a help actuator 34d which provides help information which can be displayed on the display 14. The actuators 34 can also include a plurality of numbered buttons 34e, and a clear button 34f for clearing the copier and a clear all button 34g for clearing all functions on the copier. The actuators 34a-34g can each include a separate wired connection (shown collectively at 30) connected to the computer 12 and the peripheral device 17 in any suitable known manner for providing the control signals to both the computer and the peripheral device.

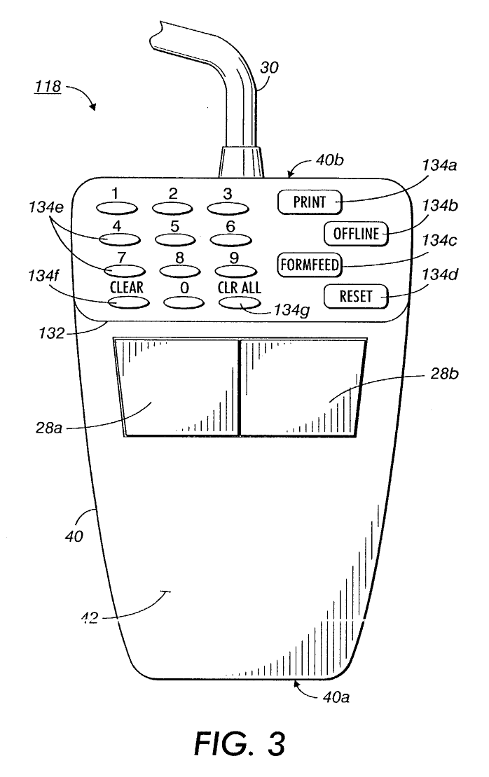

Referring now to FIG. 3, an alternate embodiment of a computer mouse is shown at 118 having a peripheral device control panel 132. The control panel 132 includes a print actuator 134a for initiating a print job on the printer 16, an offline actuator 134b for taking the printer offline, a formfeed actuator 134c for providing a formfeed at the printer, and reset actuator 134d for resetting the printer. Any other actuators from the control panel 20 of the printer can also be included on the control panel 134 of the pointing device. It should be understood that the pointing device peripheral control panel 32, 132 can include actuators for providing any suitable known control command which is available using the control panel 20 on the peripheral device 16.

It is desirable to arrange the control panel 32, 132 on the pointing device 18 in a similar configuration or layout as the control panel 20 provided on the peripheral device 16. Accordingly, the control panel 32, 132 on the pointing device 18 can include at least some of the same actuators 34, 134 arranged in a similar manner and providing the same control signals to the peripheral device 16 as the actuators provided on the peripheral device control panel 20. Such similarity enables a user already familiar with the peripheral device control panel 20 to effectively control the peripheral device 16 at a remote location without having to relearn a new control panel layout and can reduce operator errors. The pointing device's peripheral device control panel 32, 132 may only include a portion of the control actuators provided on the peripheral device's control panel 20.

Referring again to FIG. 2, the mouse 18 can include symbol control actuators 28 in the form of buttons including a left button 28a and a right button 28b. The mouse 18 can also include a housing forming a body 40 having a palm rest 42 disposed at a first end 40a of the body. The user's palm can rest on the palm rest 42 while the user's fingers can manipulate the actuators 28a, 28b and 34. In one arrangement, which should not be considered as limiting, the control panel 32 can be disposed at a second end 40b of the body and the mouse actuators 28a, 28b can be disposed between the palm rest 42 and the peripheral device control panel 32.

The invention has been described with reference to preferred embodiments. Obviously, modifications and alterations will occur to others upon reading and understanding the preceding specification. It is intended that the invention be construed as including all such modifications and alterations insofar as they come within the scope of the appended claims or the equivalents thereof.

What is claimed is:

1. A pointing device comprising
an symbol control actuator for providing user control of a graphic user interface; and
a peripheral device control panel.

2. The pointing device defined in claim 1 wherein the peripheral device control panel includes an actuator.

3. The pointing device defined in claim 2 wherein the peripheral device is a printer and the control panel actuator controls the printer.

4. The pointing device defined in claim 2 wherein the peripheral device is a copier and control panel actuator controls the copier.

5. The pointing device defined in claim 2 wherein the peripheral device is a multifunction device and the control panel actuator controls the multifunction device.

6. The pointing device defined in claim 2 wherein the peripheral device control panel actuator is a button.

7. The pointing device defined in claim 2 wherein the peripheral device control panel actuator is a wheel.

8. The pointing device defined in claim 2 wherein the peripheral device control panel actuator is a knob.

9. The pointing device defined in claim 1 wherein the pointing device is a mouse.

10. A mouse comprising:
mouse buttons for providing user control of a graphic user interface; and
a peripheral device control panel.

11. The mouse defined in claim 10 wherein the peripheral device control panel includes an actuator.

12. The mouse defined in claim 11 wherein the peripheral device control panel actuator controls a printer.

13. The mouse defined in claim 11 wherein the peripheral device control panel actuator controls a copier.

14. The mouse defined in claim 11 wherein the peripheral device control panel actuator controls a multifunction printer-copier.

15. The mouse defined in claim 11 wherein the peripheral device control panel actuator is a button.

16. The mouse defined in claim 11 wherein the peripheral device control panel actuator is a wheel.

17. The mouse defined in claim 11 wherein the peripheral device control panel actuator is a print actuator for initiating printing by a printer.

18. The mouse defined in claim 11 wherein the peripheral device control panel actuator is a copy actuator for initiating copying by a copier.

19. The mouse defined in claim 10 further comprising a body having a first end forming a palm rest and a second end disposed opposite the first end, wherein the peripheral device control panel is disposed at the second end and the mouse buttons are disposed between the peripheral device control panel and the palm rest.
